(19) United States
(12) Patent Application Publication
(10) Pub. No.: US 2020/0242193 A1
(43) Pub. Date: Jul. 30, 2020

(54) Statistical Performance Evaluation Method for Different Grouping Sets by Using Statistical Indicators

(71) Applicants: ACER INCORPORATED, New Taipei City (TW); National Yang-Ming University, Taipei (TW)

(72) Inventors: Pei-Jung Chen, New Taipei City (TW); Tsung-Hsien Tsai, New Taipei City (TW); Liang-Kung Chen, Taipei (TW); Li-Ning Peng, Taipei (TW); Wei-Ju Li, Taipei (TW)

(21) Appl. No.: 16/420,183

(22) Filed: May 23, 2019

(30) Foreign Application Priority Data
Jan. 29, 2019 (TW) 108103377

(51) Int. Cl. G06F 17/18; G06F 17/17; G06F 17/16; G06F 17/15; G06K 9/62

(52) U.S. Cl. CPC G06F 17/18; G06F 17/175; G06K 9/6265; G06F 17/15; G06F 17/16

(57) ABSTRACT

A statistical performance evaluation method for different grouping sets includes setting a plurality of first grouping ranges of a first grouping set corresponding to a sample space, setting a plurality of second grouping ranges of a second grouping set corresponding to the sample space, generating a plurality of first probability values and a plurality of first standard deviations corresponding to the plurality of first grouping ranges at each sampling time according to the sample space, generating a plurality of second probability values and a plurality of second standard deviations corresponding to the plurality of second grouping ranges at the each sampling time according to the sample space, and generating a plurality of statistical indicators corresponding to the first grouping set and the second grouping set and outputting a statistical performance ranking result of the first grouping set and the second grouping set accordingly.

### BACKGROUND OF THE INVENTION

### 1. Field of the Invention

The present invention illustrates a statistical performance evaluation method for different grouping sets, and more particularly, a statistical performance evaluation method capable of generating a performance ranking sequence for different grouping sets by using statistical indicators.

### 2. Description of the Prior Art

With the rapid development of technologies, medical technology can be regarded as a mature technology in recent years. Nowadays, many medical procedures, pharmaceutical experiments, or disease management often use medical data statistics of patients for evaluating their performance. For example, a physician can analyze a probability of death correlated to a disease count in order to establish different risk levels. In current medical technology, a frailty index is commonly used as a disease management indicator. The frailty index corresponds to the probability of death correlated to the disease count of the patients. The disease count is defined as the number of diseases for a specific disease set (i.e., for example, a set of 32 different diseases) infecting to each patient.

When the frailty index is used for disease management, the number of diseases can be partitioned into several numerical ranges corresponding to appropriate risks of death. For example, when a patient is infected by 0˜2 diseases, a risk of death is low. Therefore, the patient with 0˜2 diseases can be regarded as a low-risk patient. When a patient is infected by 3˜5 diseases, a risk of death is medium. Therefore, the patient with 3˜5 diseases can be regarded as a medium-risk patient. When a patient is infected by 6˜8 diseases, a risk of death is high. Therefore, the patient with 6˜8 diseases can be regarded as a high-risk patient. When a patient is infected by more than 9 diseases, a risk of death is extremely high. Therefore, the patient with more than 9 diseases can be regarded as an extremely high-risk patient. In other words, when the disease management is in progress, for the set of 32 different diseases, a disease count group of the patient can be defined as {[0˜2], [3˜5], [6˜8], [9˜32] }. However, for the set of 32 different diseases, the disease count group of the patient can be arbitrarily defined. For example, another disease count group can be defined as {[0˜1], [2˜7], [8˜10], [11˜32] }.

At present, when the frailty index is used for disease management, for the disease count group, the number of diseases corresponding to each risk of death can only be determined by using a manual configuration process. Further, after a lot of disease count groups are determined, statistical performances of the different disease count groups can only be evaluated by a subjective judgment of the physician. For example, the physician can subjectively determine statistical performances of the disease count group {[0˜2], [3˜5], [6˜8], [9˜32] } and the disease count group {[0˜1], [2˜7], [8˜10], [11˜32]}. However, nowadays, no automated or systematic mechanism is introduced for determining statistical performances of the different disease count groups. Therefore, when the frailty index is used for disease management, huge manpower resource requirement is unavoidable. Further, since no definite decision rule is introduced, the current statistical performance evaluation method suffers from low accuracy issues.

### SUMMARY OF THE INVENTION

In an embodiment of the present invention, a statistical performance evaluation method for different grouping sets is disclosed. The statistical performance evaluation method comprises setting a plurality of first grouping ranges of a first grouping set corresponding to a sample space, setting a plurality of second grouping ranges of a second grouping set corresponding to the sample space, generating a plurality of first probability values and a plurality of first standard deviations corresponding to the plurality of first grouping ranges at each sampling time according to the sample space, generating a plurality of second probability values and a plurality of second standard deviations corresponding to the plurality of second grouping ranges at the each sampling time according to the sample space, generating a plurality of statistical indicators corresponding to the first grouping set and the second grouping set and outputting a statistical performance ranking result of the first grouping set and the second grouping set accordingly. The sample space is a time-varying random process-based sample space. The plurality of statistical indicators are generated according to the plurality of first probability values and/or the plurality of first standard deviations corresponding to the plurality of first grouping ranges at each sampling time, and according to the plurality of second probability values and/or the plurality of second standard deviations corresponding to the plurality of second grouping ranges at the each sampling time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a statistical performance evaluation system according to the embodiment of the present invention.

FIG. 2 is an illustration of a plurality of statistical characteristics of a plurality of first grouping ranges of a first grouping set corresponding to a sample space generated by the statistical performance evaluation system in FIG. 1.

FIG. 3 is an illustration of a plurality of statistical characteristics of a plurality of second grouping ranges of a second grouping set corresponding to the sample space generated by the statistical performance evaluation system in FIG. 1.

FIG. 4 is a flow chart of the statistical performance evaluation method performed by the statistical performance evaluation system in FIG. 1.

### DETAILED DESCRIPTION

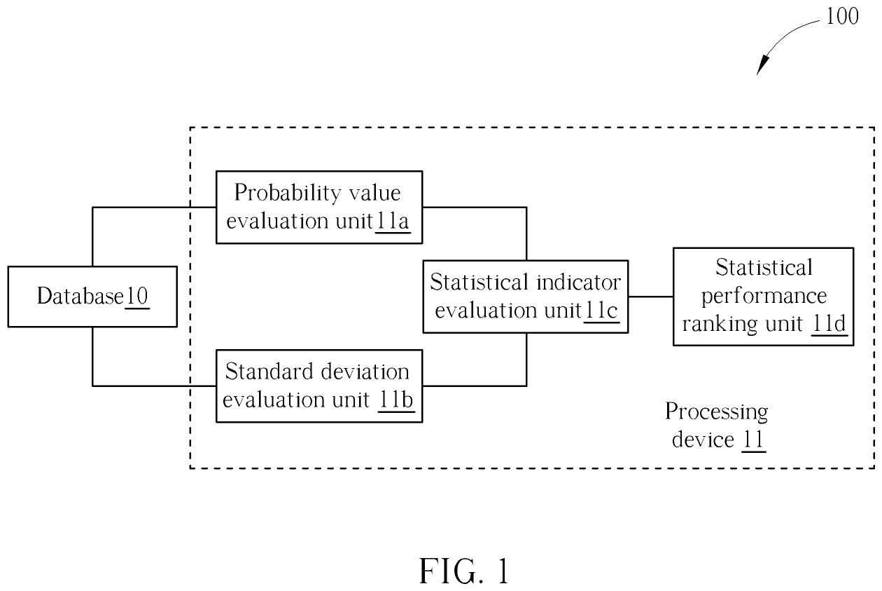

FIG. 1 is a block diagram of a statistical performance evaluation system 100 according to the embodiment of the present invention. The statistical performance evaluation system 100 is capable of generating a statistical performance ranking result of different grouping sets automatically. Further, the statistical performance evaluation system 100 can be applied to any analytical process for numerical or statistical data in any technology field. Particularly, for simplicity, the statistical performance evaluation system 100 is illustrated in terms of applying to disease management and death risk management in a medical technology hereafter. The statistical performance evaluation system 100 includes a database 10 and a processing device 11. The database 10 can be any type of memory storage space, such as a memory of a cloud server or a hard disk of a computer for saving patient's data. The processing device can be any hardware capable of performing numerical data computation, such as a computer, a work station, or a server. The database 10 can be used for saving a sample space, a first grouping set of the sample space, and a second grouping set of the sample space. Specifically, more than two grouping sets (i.e., a lot of various grouping sets) can be saved to the database 10. However, for simplicity, in the following description, two grouping sets are introduced to the statistical performance evaluation system 100 for ranking their statistic performances. The processing device 11 is coupled to the database 10. The processing device 11 can include a probability value evaluation unit 11a, a standard deviation evaluation unit lib, a statistical indicator evaluation unit 11c, and a statistical performance ranking unit 11d. The probability value evaluation unit 11a and the standard deviation evaluation unit 11b are coupled to the database 10. The statistical indicator evaluation unit 11c is coupled to the probability value evaluation unit 11a and the standard deviation evaluation unit lib. The statistical performance ranking unit 11d is coupled to the statistical indicator evaluation unit 11c. In the statistical performance evaluation system 100, the probability value evaluation unit 11a, the standard deviation evaluation unit 11b, the statistical indicator evaluation unit 11c, and the statistical performance ranking unit 11d are not limited to specific modules. For example, the probability value evaluation unit 11a, the standard deviation evaluation unit lib, the statistical indicator evaluation unit 11c, and the statistical performance ranking unit 11d can be software package modules driven by application programs, hardware modules, or command functions performed by using programming language files. Any reasonable module or technology modification of the processing device 11 falls into the scope of the present invention. In the statistical performance evaluation system 100, the processing device 11 can set a plurality of first grouping ranges of a first grouping set corresponding to the sample space stored in the database 10. The processing device 11 can set a plurality of second grouping ranges of a second grouping set corresponding to the sample space stored in the database 10. The probability value evaluation unit 11a can generate a plurality of first probability values corresponding to the plurality of first grouping ranges at each sampling time according to the sample space. The probability value evaluation unit 11a can generate a plurality of second probability values corresponding to the plurality of second grouping ranges at the each sampling time according to the sample space. The standard deviation evaluation unit 11b can generate a plurality of first standard deviations corresponding to the plurality of first grouping ranges at the each sampling time according to the sample space. The standard deviation evaluation unit 11b can generate a plurality of second standard deviations corresponding to the plurality of second grouping ranges at the each sampling time according to the sample space. Further, the statistical indicator evaluation unit 11c can generate a plurality of statistical indicators corresponding to the first grouping set and the second grouping set. Then, the statistical performance ranking unit 11d can output a statistical performance ranking result of the first grouping set and the second grouping set according to the plurality of statistical indicators corresponding to the first grouping set and the second grouping set. In the statistical performance evaluation system 100, the sample space is a time-varying random process-based sample space. Further, the plurality of statistical indicators can be generated by using the statistical indicator evaluation unit 11c according to the plurality of first probability values and/or the plurality of first standard deviations corresponding to the plurality of first grouping ranges at each sampling time, and according to the plurality of second probability values and/or the plurality of second standard deviations corresponding to the plurality of second grouping ranges at the each sampling time. Details of the statistical performance evaluation system 100 applied to manage death risks in conjunction with several disease counts in the medical technology field are illustrated later.

As previously mentioned, the sample space is the time-varying random process-based sample space. For example, the sample space can include data of patients. The data of each patient can include a variation of a physical condition over time. For example, a patient was infected by three diseases two years ago. The patient was infected by one disease three years ago. Therefore, it can be expected that each patient's health in the sample space may be satisfactory when the data of the each patient is sampled at a beginning time (i.e., an average number of infected diseases by patients is small). As time progressed, the patient's health in the sample space is getting worse since the average number of infected diseases by patients is increased. Therefore, for the each patient, a risk of death is increased over time. The first grouping set includes the plurality of first grouping ranges. For example, the first grouping set includes four first grouping ranges, such as {0, [1˜3], 4, [>=5]}. In other words, the first grouping set {0, [1˜3], 4, [>=5]} includes: (1) patients infected by zero diseases, (2) patients infected by 1˜3 diseases, (3) patients infected by 4 diseases, and (4) patients infected by more than 5 diseases. The second grouping set includes the plurality of second grouping ranges. For example, the second grouping set includes four second grouping ranges, such as {[0˜3], 4, [5˜6], [>=7]}. In other words, the second grouping set {[0˜3], 4, [5˜6], [>=7]} includes: (1) patients infected by 0˜3 diseases, (2) patients infected by 4 diseases, (3) patients infected by 5˜6 diseases, and (4) patients infected by more than 7 diseases. Here, a purpose of the statistical performance evaluation system 100 is to provide an automatic and systematic statistical performance evaluation method for comparing a statistical performance of the first grouping set with a statistical performance of the second grouping set. In other words, the statistical performance evaluation system 100 is informative since it can determine whether the grouping ranges are suitable for analyzing the statistic of the sample space or not.

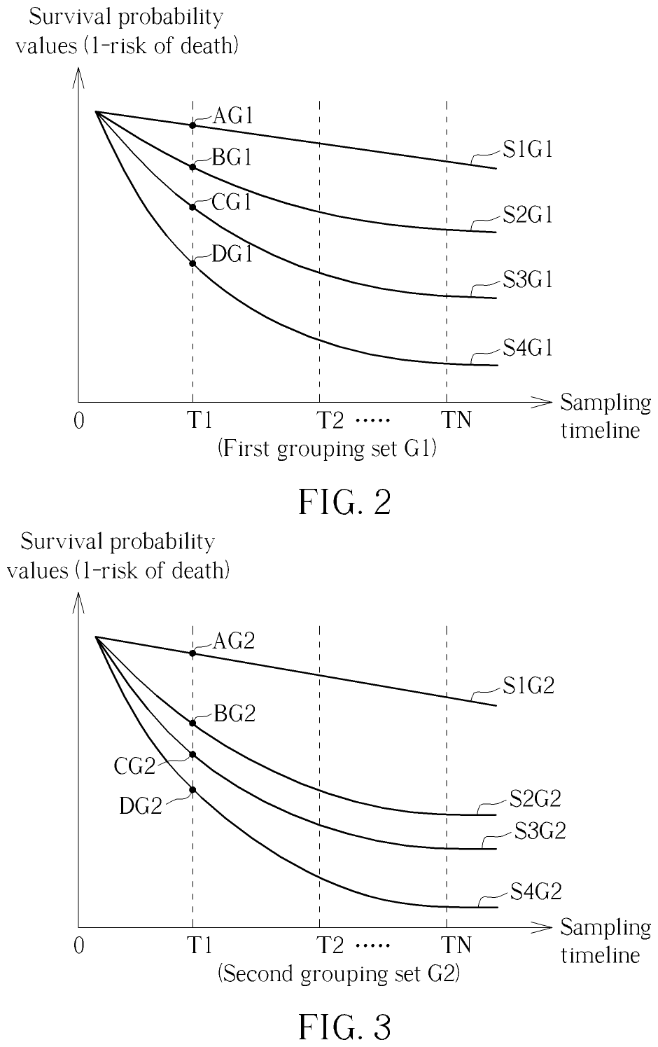

FIG. 2 is an illustration of a plurality of statistical characteristics of the plurality of first grouping ranges of the first grouping set G1 corresponding to the sample space generated by the statistical performance evaluation system 100. As previously mentioned, the first grouping set G1 can include four first grouping ranges, such as {0, [1˜3], 4, [>=5]}. Therefore, at the sampling time T1, the probability value evaluation unit 11a and the standard deviation evaluation unit 11b can generate a plurality of first probability values and a plurality of first standard deviations of the first grouping ranges “0”, “[1˜3]”, “4”, and [>=5]. For example, a probability curve of a first grouping range “0” can be denoted as S1G1. At the sampling time T1, a characteristic point of the probability curve S1G1 in the sample space is denoted as AG1. A first probability value 0.43 and a first standard deviation 0.025 of the characteristic point AG1 can be generated. A probability curve of a first grouping range “[1˜3]” can be denoted as S2G1. At the sampling time T1, a characteristic point of the probability curve S2G1 in the sample space is denoted as BG1. A first probability value 0.60 and a first standard deviation 0.021 of the characteristic point BG1 can be generated. A probability curve of a first grouping range “4” can be denoted as S3G1. At the sampling time T1, a characteristic point of the probability curve S3G1 in the sample space is denoted as CG1. A first probability value 0.76 and a first standard deviation 0.0058 of the characteristic point CG1 can be generated. A probability curve of a first grouping range “[>=5]” can be denoted as S4G1. At the sampling time T1, a characteristic point of the probability curve S4G1 in the sample space is denoted as DG1. A first probability value 0.91 and a first standard deviation 0.0012 of the characteristic point DG1 can be generated. Here, the first probability values can be regarded as risks of death. Here, the first grouping range “0”, the first grouping range “[1˜3]”, the first grouping range “4”, and the first grouping range “[>=5]” form the first grouping set G1. Therefore, the plurality of first grouping ranges in the first grouping set G1 are non-overlapped. In FIG. 2, X-axis corresponds to a sampling timeline. Y-axis corresponds to survival probability values. A survival probability value is equal to 1-risk of death. Therefore, by observing trends of the probability curve S1G1 to the probability curve S4G1, the risks of death are increased over time. It implies that the survival probability values are decreased over time. Further, when a patient is infected by a lot of deceases, the risk of death is increased since the survival probability value is decreased. At the sampling time T1, the probability value evaluation unit 11a and the standard deviation evaluation unit 11b can generate the plurality of statistical characteristics of the plurality of first grouping ranges “0”, “[1˜3]”, “4”, and [>=5], as shown in Table 1.

TABLE 1

| First | | | |
|---|---|---|---|
| grouping | Risk of death | First probability | First standard |
| range | (Degree) | value | deviation |
| 0 | Low | 0.43 | 0.025 |
| 1~3 | Medium | 0.60 | 0.021 |
| 4 | High | 0.76 | 0.0058 |
| >=5 | Extremely | 0.91 | 0.0012 |
| | High | | |

Further, the first probability values and the first standard deviations in Table 1 are generated based on the sampling time T1. However, the probability value evaluation unit 11a and the standard deviation evaluation unit 11b can generate all first probability values and all first standard deviations for all possible sampling times. For example, for a sampling time T2, the probability value evaluation unit 11a and the standard deviation evaluation unit 11b can generate corresponding first probability values and standard deviations of the first grouping ranges {0, [1˜3], 4, [>=5]}, and so on. For a sampling time TN, the probability value evaluation unit 11a and the standard deviation evaluation unit 11b can generate corresponding first probability values and standard deviations of the first grouping ranges {0, [1˜3], 4, [>=5]}. However, the statistical performance evaluation system 100 is not limited to a specific number of sampling times. In other words, N can be any positive integer.

FIG. 3 is an illustration of a plurality of statistical characteristics of a plurality of second grouping ranges of a second grouping set G2 corresponding to the sample space generated by the statistical performance evaluation system in FIG. 1. As previously mentioned, the second grouping set G2 can include four second grouping ranges, such as {[0˜3], 4, [5˜6], [>=7] }. Therefore, at the sampling time T1, the probability value evaluation unit 11a and the standard deviation evaluation unit 11b can generate a plurality of second probability values and a plurality of second standard deviations of the second grouping ranges “[0˜3]”, “4”, “[5˜6]”, and [>=7]. For example, a probability curve of a second grouping range “[0˜3]” can be denoted as S1G2. At the sampling time T1, a characteristic point of the probability curve S1G2 in the sample space is denoted as AG2. A second probability value 0.33 and a second standard deviation 0.051 of the characteristic point AG2 can be generated. A probability curve of a second grouping range “4” can be denoted as S2G2. At the sampling time T1, a characteristic point of the probability curve S2G2 in the sample space is denoted as BG2. A second probability value 0.049 and a second standard deviation 0.028 of the characteristic point BG2 can be generated. A probability curve of a second grouping range “[5˜6]” can be denoted as S3G2. At the sampling time T1, a characteristic point of the probability curve S3G2 in the sample space is denoted as CG2. A second probability value 0.60 and a second standard deviation 0.021 of the characteristic point CG2 can be generated. A probability curve of a second grouping range “[>=7]” can be denoted as S4G2. At the sampling time T1, a characteristic point of the probability curve S4G2 in the sample space is denoted as DG2. A second probability value 0.89 and a second standard deviation 0.0012 of the characteristic point DG2 can be generated. Here, the second probability values can be regarded as risks of death. Here, the second grouping range “[0˜3]”, the second grouping range “4”, the second grouping range “[5˜6]”, and the second grouping range “[>=7]” form the second grouping set G2. Therefore, the plurality of second grouping ranges in the second grouping set G2 are non-overlapped. In FIG. 3, X-axis corresponds to a sampling timeline. Y-axis corresponds to survival probability values. A survival probability value is equal to 1-risk of death. Therefore, by observing trends of the probability curve S1G2 to the probability curve S4G2, the risks of death are increased over time. It implies that the survival probability values are decreased over time. Further, when a patient is infected by a lot of deceases, the risk of death is increased since the survival probability value is decreased. At the sampling time T1, the probability value evaluation unit 11a and the standard deviation evaluation unit 11b can generate the plurality of statistical characteristics of the plurality of second grouping ranges “[0˜3]”, “4”, “[5˜6]”, and [>=7], as shown in Table 2.

TABLE 2

| Second | | | |
|---|---|---|---|
| grouping | Risk of death | Second probability | Second standard |
| range | (Degree) | value | deviation |
| 0~3 | Low | 0.33 | 0.051 |
| 4 | Medium | 0.49 | 0.028 |
| 5~6 | High | 0.60 | 0.021 |
| >=7 | Extremely | 0.89 | 0.0012 |
| | High | | |

Further, the second probability values and the second standard deviations in Table 2 are generated based on the sampling time T1. However, the probability value evaluation unit 11a and the standard deviation evaluation unit 11b can generate all second probability values and all second standard deviations for all possible sampling times. For example, for the sampling time T2, the probability value evaluation unit 11a and the standard deviation evaluation unit 11b can generate corresponding second probability values and standard deviations of the second grouping ranges {[0˜3], 4, [5˜6], [>=7] }, and so on. For the sampling time TN, the probability value evaluation unit 11a and the standard deviation evaluation unit 11b can generate corresponding second probability values and standard deviations of the second grouping ranges {[0˜3], 4, [5˜6], [>=7]}. In the following, several statistical performance evaluation methods are introduced. Algorithms and details of the statistical performance evaluation methods are also illustrated later.

In the statistical performance evaluation system 100, a first statistical performance evaluation method can be performed by introducing distinguishing indicators. Details are illustrated below. The statistical indicator evaluation unit 11c can generate a plurality of first probability differences of a plurality of pair-wised first grouping ranges at the each sampling time according to the plurality of first probability values of the plurality of first grouping ranges at the each sampling time. For example, in Table 1, at the sampling time T1, a first probability difference 0.17 can be derived according to the first probability value 0.43 of the first grouping range “0” and the first probability value 0.60 of the first grouping range “[1˜3]” (i.e., 0.17=0.60−0.43). A first probability difference 0.16 can be derived according to the first probability value 0.60 of the first grouping range “[1˜3]” and the first probability value 0.76 of the first grouping range “4” (i.e., 0.16=0.76−0.60). A first probability difference 0.15 can be derived according to the first probability value 0.76 of the first grouping range “4” and the first probability value 0.91 of the first grouping range “[>=5]” (i.e., 0.15=0.91−0.76). Then, the statistical indicator evaluation unit 11c can generate an average value and a standard deviation of the plurality of first probability differences at the each sampling time. For example, the average value 0.16 and the standard deviation 0.01 of the first probability differences {0.17, 0.16, 0.15} can be derived. Then, the statistical indicator evaluation unit 11c can generate a first distinguishing indicator at the each sampling time according to the average value and the standard deviation of the plurality of first probability differences. The first distinguishing indicator is a ratio of the average value of the first probability differences to the standard deviation of the first probability differences. For example, in Table 1, at the sampling time T1, the first distinguishing indicator can be derived as 0.16/0.01=16. In other words, at the sampling time T1, the first distinguishing indicator can be regarded as a statistical discrete degree of characteristic points AG1, BG1, CG1, and DG1. Further, the statistical indicator evaluation unit 11c can generate all first distinguishing indicators for all sampling times T1 to TN. For example, the first distinguishing indicator at the sampling time T1 can be denoted as D₁(T1). A first distinguishing indicator at the sampling time T2 can be denoted as D₁(T2). A first distinguishing indicator at the sampling time TN can be denoted as D₁(TN). Further, the statistical indicator evaluation unit 11c can acquire a minimal first distinguishing indicator minD₁ of the first grouping set G1 for all sampling times T1 to TN. Therefore, the minimal first distinguishing indicator minD₁ can be written as:

minD₁=min{D₁(T1),D₁(T2),D₁(T3), . . . ,D₁(TN)}

Therefore, the minimal first distinguishing indicator minD₁ of the first grouping set G1 can be regarded as a worst case of the statistical discrete degree of the characteristic points for all sampling times T1 to TN.

Similarly, the statistical indicator evaluation unit 11c can generate a plurality of second probability differences of a plurality of pair-wised second grouping ranges at the each sampling time according to the plurality of second probability values of the plurality of second grouping ranges at the each sampling time. For example, in Table 2, at the sampling time T1, a second probability difference 0.16 can be derived according to the second probability value 0.33 of the second grouping range “[0˜3]” and the second probability value 0.49 of the second grouping range “4” (i.e., 0.16=0.49−0.33). A second probability difference 0.11 can be derived according to the second probability value 0.49 of the second grouping range “4” and the second probability value 0.60 of the second grouping range “[5˜6]” (i.e., 0.11=0.60−0.49). A second probability difference 0.29 can be derived according to the second probability value 0.60 of the second grouping range “[5˜6]” and the second probability value 0.89 of the first grouping range “[>=7]” (i.e., 0.29=0.89−0.60). Then, the statistical indicator evaluation unit 11c can generate an average value and a standard deviation of the plurality of second probability differences at the each sampling time. For example, the average value 0.187 and the standard deviation 0.09 of the second probability differences {0.16, 0.11, 0.29} can be derived. Then, the statistical indicator evaluation unit 11c can generate a second distinguishing indicator at the each sampling time according to the average value and the standard deviation of the plurality of second probability differences. The second distinguishing indicator is a ratio of the average value of the second probability differences to the standard deviation of the second probability differences. For example, in Table 2, at the sampling time T1, the second distinguishing indicator can be derived as 0.187/0.09=2.07. In other words, at the sampling time T1, the second distinguishing indicator can be regarded as a statistical discrete degree of characteristic points AG2, BG2, CG2, and DG2. Further, the statistical indicator evaluation unit 11c can generate all second distinguishing indicators for all sampling times T1 to TN. For example, the second distinguishing indicator at the sampling time T1 can be denoted as D₂(T1). A second distinguishing indicator at the sampling time T2 can be denoted as D₂(T2). A second distinguishing indicator at the sampling time TN can be denoted as D₂(TN). Further, the statistical indicator evaluation unit 11c can acquire a minimal second distinguishing indicator minD₂ of the second grouping set G2 for all sampling times T1 to TN. Therefore, the minimal second distinguishing indicator minD₂ can be written as:

minD₂=min{D₂(T1),D₂(T2),D₂(T3), . . . ,D₂(TN)}

Therefore, the minimal second distinguishing indicator minD₂ of the second grouping set G2 can be regarded as a worst case of the statistical discrete degree of the characteristic points for all sampling times T1 to TN.

As previously mentioned, the plurality of statistical indicators generated by the statistical indicator evaluation unit 11c can include the minimal first distinguishing indicator minD₁ of the first grouping set G1 and the minimal second distinguishing indicator minD₂ of the second grouping set G2. Further, the statistical performance ranking unit 11d can generate a performance ranking result. For example, the statistical performance of the first grouping set G1 is greater than the statistical performance of the second grouping set G2 when the minimal first distinguishing indicator minD₁ is greater than the minimal second distinguishing indicator minD₂. In other words, a decision rule for selecting a grouping set with a better statistical performance by using the statistical performance ranking unit 11d can be written as:

max{minD₁,minD₂}

In other words, the statistical performance ranking unit 11d can use the decision rule of max-min algorithm for selecting the grouping set with the better statistical performance. Therefore, the selected grouping set has satisfactory statistical performance since no severe discrete distribution of samples is introduced to the selected grouping set for all sampling time.

In the statistical performance evaluation system 100, a second statistical performance evaluation method can be performed by introducing error degrees. Details are illustrated below. The statistical indicator evaluation unit 11c can generate a first standard deviation coverage value at the each sampling time by using a linear combination function according to the plurality of first standard deviations corresponding to the plurality of first grouping ranges at the each sampling time. For example, in Table 1, at the sampling time T1, a first standard deviation coverage value 0.0798 can be generated according to the first standard deviation 0.025 of the first grouping range “0”, the first standard deviation 0.021 of the first grouping range “[1˜3]”, the first standard deviation 0.0058 of the first grouping range “4”, and the first standard deviation 0.0012 of the first grouping range “[>=5]”. The first standard deviation coverage value 0.0798 can be derived by 0.0798=0.025+2×0.021+2×0.0058+0.0012 (i.e., linear combination function). Further, the statistical indicator evaluation unit 11c can generate a maximum first probability difference of the plurality of first probability values at the each sampling time according to the plurality of first probability values corresponding to the plurality of first grouping ranges at the each sampling time. For example, in Table 1, at the sampling time T1, a maximum first probability difference 0.48 can be derived according to the first probability value 0.43 of the first grouping range “0”, the first probability value 0.60 of the first grouping range “[1˜3]”, the first probability value 0.76 of the first grouping range “4”, and the first probability value 0.91 of the first grouping range “[>=5]” (i.e., 0.91−0.43=0.48). Then, the statistical indicator evaluation unit 11c can generate a first error degree at the each sampling time according to the first standard deviation coverage value and the maximum first probability difference. The first error degree is a ratio of the first standard deviation coverage value to the maximum first probability difference. For example, in Table 1, at the sampling time T1, the first error degree can be derived as 0.0798/0.48=0.166. In other words, at the sampling time T1, the first error degree can be regarded as a data concentration degree of sampling distribution in the sample space corresponding to the probability curves S1G1, S2G1, S3G1, and S4G1. Further, the statistical indicator evaluation unit 11c can generate all first error degrees for all sampling times T1 to TN. For example, the first error degree at the sampling time T1 can be denoted as E₁(T1). A first error degree at the sampling time T2 can be denoted as E₁(T2). A first error degree at the sampling time TN can be denoted as E₁(TN). Further, the statistical indicator evaluation unit 11c can acquire a maximum first error degree maxE₁ of the first grouping set G1 for all sampling times T1 to TN. Therefore, the maximum first error degree maxE₁ can be written as:

maxE₁=max{E₁(T1),E₁(T2),E₁(T3), . . . ,E₁(TN)}

Therefore, the maximum first error degree maxE₁ of the first grouping set G1 can be regarded as a worst case of the data concentration degree corresponding to the probability curves for all sampling times T1 to TN.

Similarly, the statistical indicator evaluation unit 11c can generate a second standard deviation coverage value at the each sampling time by using the linear combination function according to the plurality of second standard deviations corresponding to the plurality of second grouping ranges at the each sampling time. For example, in Table 2, at the sampling time T1, a second standard deviation coverage value 0.1502 can be generated according to the second standard deviation 0.051 of the second grouping range “[0˜3]”, the second standard deviation 0.028 of the second grouping range “4”, the second standard deviation 0.0021 of the second grouping range “[5˜6]”, and the second standard deviation 0.0012 of the second grouping range “[>=7]”. The second standard deviation coverage value 0.1502 can be derived by 0.1502=0.051+2×0.028+2×0.021+0.0012 (i.e., linear combination function). Further, the statistical indicator evaluation unit 11c can generate a maximum second probability difference of the plurality of second probability values at the each sampling time according to the plurality of second probability values corresponding to the plurality of second grouping ranges at the each sampling time. For example, in Table 2, at the sampling time T1, a maximum second probability difference 0.56 can be derived according to the second probability value 0.33 of the second grouping range “[0˜3]”, the second probability value 0.49 of the second grouping range “4”, the second probability value 0.60 of the second grouping range “[5˜6]”, and the second probability value 0.89 of the second grouping range “[>=7]” (i.e., 0.89−0.56=0.33). Then, the statistical indicator evaluation unit 11c can generate a second error degree at the each sampling time according to the second standard deviation coverage value and the maximum second probability difference. The second error degree is a ratio of the second standard deviation coverage value to the maximum second probability difference. For example, in Table 2, at the sampling time T1, the second error degree can be derived as 0.1502/0.56=0.268. In other words, at the sampling time T1, the second error degree can be regarded as a data concentration degree of sampling distribution in the sample space corresponding to the probability curves S1G2, S2G2, S3G2, and S4G2. Further, the statistical indicator evaluation unit 11c can generate all second error degrees for all sampling times T1 to TN. For example, the second error degree at the sampling time T1 can be denoted as E₂(T1). A second error degree at the sampling time T2 can be denoted as E₂(T2). A second error degree at the sampling time TN can be denoted as E₂(TN). Further, the statistical indicator evaluation unit 11c can acquire a maximum second error degree maxE₂ of the second grouping set G2 for all sampling times T1 to TN. Therefore, the maximum second error degree maxE₂ can be written as:

maxE₂=max{E₂(T1),E₂(T2),E₂(T3), . . . ,E₂(TN)}

Therefore, the maximum second error degree maxE₂ of the second grouping set G2 can be regarded as a worst case of the data concentration degree corresponding to the probability curves for all sampling times T1 to TN.

As previously mentioned, the plurality of statistical indicators generated by the statistical indicator evaluation unit 11c can include the maximum first error degree maxE₁ of the first grouping set G1 and the maximum second error degree maxE₂ of the second grouping set G2. Further, the statistical performance ranking unit 11d can generate a performance ranking result. For example, the statistical performance of the first grouping set G1 is greater than the statistical performance of the second grouping set G2 when the maximum first error degree maxE₁ is smaller than the maximum second error degree maxE₂. In other words, a decision rule for selecting a grouping set with a better statistical performance by using the statistical performance ranking unit 11d can be written as:

min{maxE₁,maxE₂}

In other words, the statistical performance ranking unit 11d can use the decision rule of min-max algorithm for selecting the grouping set with the better statistical performance. Therefore, the selected grouping set has satisfactory statistical performance since fluctuation of data distribution for each probability curve is minimized for all sampling time.

In the statistical performance evaluation system 100, a third statistical performance evaluation method can be performed by introducing comprehensive indicators. Details are illustrated below. The comprehensive indicators can include ranking sums or user-defined weighting values. The statistical performance ranking unit 11d can acquire a first ranking sum of the first grouping set G1 according to the plurality of statistical indicators, such as the distinguishing indicators and error degrees. Similarly, the statistical performance ranking unit 11d can acquire a second ranking sum of the second grouping set G2 according to the plurality of statistical indicators, such as the distinguishing indicators and error degrees, as shown in Table 3.

TABLE 3

| | Distinguishing | | | | |
|---|---|---|---|---|---|
| | indicators | Rank | Error degrees | Rank | Ranking sum |
| First | Minimal first | 1 | Maximum first | 1 | First |
| grouping | distinguishing | | error degree | | ranking |
| set G1 | indicator | | maxE₁ = 0.166 | | sum: 1 + 1 = 2 |
| | minD₁ = 16 | | | | |
| Second | Minimal second | 2 | Maximum second | 2 | Second |
| grouping | distinguishing | | error degree | | ranking |
| set G2 | indicator | | maxE₂ = 0.268 | | sum: 2 + 2 = 4 |
| | minD₂ = 2.07 | | | | |

The first ranking sum and the second ranking sum are two integers greater than two. Further, in Table 3, when the first ranking sum “2” is smaller than the second ranking sum “4”, the statistical performance of the first grouping set G1 is greater than the statistical performance of the second grouping set G2. However, the comprehensive indicators of the statistical performance evaluation system 100 can be user-defined weighting values. The statistical performance ranking unit 11d can set a plurality of weighting values corresponding to the plurality of statistical indicators. For example, different weighting values of the minimal first distinguishing indicator minD₁, the minimal second distinguishing indicator minD₂, the maximum first error degree maxE₁, the maximum second error degree maxE₂ can be predetermined. Then, the statistical performance ranking unit 11d can generate a first comprehensive indicator of the first grouping set G1 by using a linear or a non-linear combination function according to the plurality of weighting values. The statistical performance ranking unit 11d can generate a second comprehensive indicator of the second grouping set G2 by using the linear or the non-linear combination function according to the plurality of weighting values. Further, the plurality of weighting values can be integers or floating point numbers. The first comprehensive indicator and the second comprehensive indicator can be integers or floating point numbers. The statistical performance ranking unit 11d can generate a statistical performance ranking result of the first grouping set G1 and the second grouping set G2 according to the first comprehensive indicator and the second comprehensive indicator.

In the statistical performance evaluation method of the present invention, any reasonable technology modification falls into the scope of the present invention. For example, when probability models in FIG. 2 and FIG. 3 are established by the processing device 11, sampling data for a short sampling time interval (i.e., for example, within 0˜100 days) can be ignored. The reason is illustrated below. Since four probability curves are almost overlapped within the short sampling time interval from 0 to 100 days (i.e., survival probabilities are almost equal to one), statistic characteristics from 0 to 100 days result in low reference value. Therefore, the sampling data for the short sampling time interval can be ignored for reducing computational complexity.

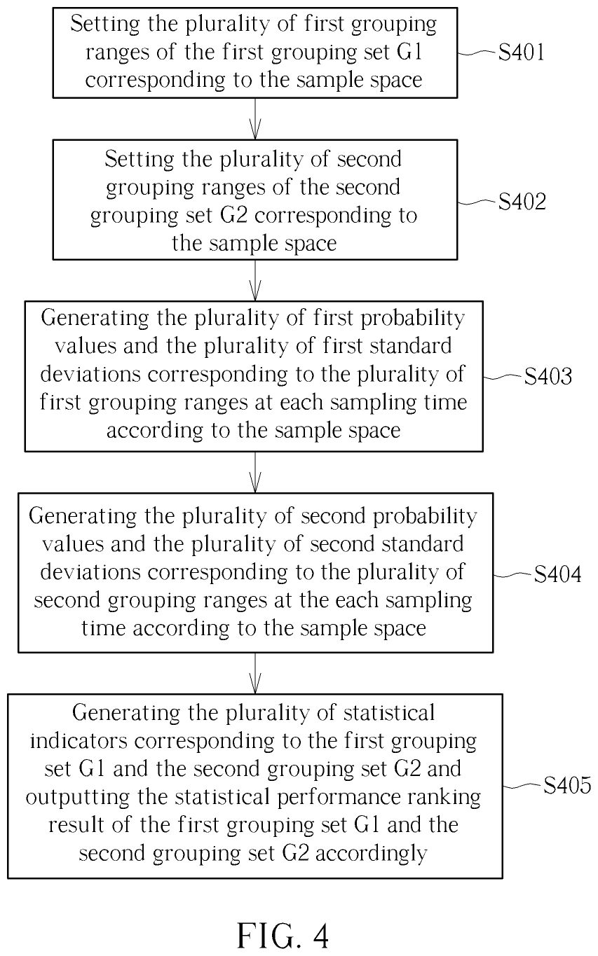

FIG. 4 is a flow chart of the statistical performance evaluation method performed by the statistical performance evaluation system 100. The statistical performance evaluation method includes step S401 to step S405. Any reasonable technology modification falls into the scope of the present invention. Step S401 to step S405 are illustrated below.
step S401: setting the plurality of first grouping ranges of the first grouping set G1 corresponding to the sample space;
step S402: setting the plurality of second grouping ranges of the second grouping set G2 corresponding to the sample space;
step S403: generating the plurality of first probability values and the plurality of first standard deviations corresponding to the plurality of first grouping ranges at each sampling time according to the sample space;
step S404: generating the plurality of second probability values and the plurality of second standard deviations corresponding to the plurality of second grouping ranges at the each sampling time according to the sample space;
step S405: generating the plurality of statistical indicators corresponding to the first grouping set G1 and the second grouping set G2 and outputting the statistical performance ranking result of the first grouping set G1 and the second grouping set G2 accordingly.

Details of step S401 to step S405 are illustrated previously. Thus, they are omitted here. By using step S401 to step S405, the statistical performance evaluation system 100 can evaluate statistical performances of different grouping sets automatically. Therefore, the manpower resource requirement can be greatly reduced. Evaluation accuracy can also be increased.

To sum up, the present invention discloses a statistical performance evaluation method and a statistical performance evaluation system for different grouping sets. The statistical performance evaluation system can generate a plurality of statistical indicators (such as distinguishing indicators, error degrees, and comprehensive indicators) according to probability values and standard deviations of the sample space for all sampling times. Further, the statistical performance evaluation system can automatically generates a statistical performance ranking result of the different grouping sets according to the plurality of statistical indicators. Thus, when the statistical performance evaluation system is applied in medical technology, the statistical performance evaluation system can be used for selecting an optimal grouping set of disease count ranges automatically. Therefore, gaps of different probability curves corresponding to different death risk levels can be increased for facilitating a statistical analysis process. Further, a data concentration degree of the sampling distribution in the sample space can also be improved for minimizing data variances of probability curves of death risk levels. Moreover, the statistical performance evaluation system can also be applied to physiological data control management (i.e., such as blood pressure control management) and healthy risk data management (i.e., such as healthy risk data management of heart diseases). By using the statistical performance evaluation system of the present invention, an optimal physiological data grouping pattern can be selected automatically.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A statistical performance evaluation method for different grouping sets comprising:
setting a plurality of first grouping ranges of a first grouping set corresponding to a sample space;
setting a plurality of second grouping ranges of a second grouping set corresponding to the sample space;
generating a plurality of first probability values and a plurality of first standard deviations corresponding to the plurality of first grouping ranges at each sampling time according to the sample space;
generating a plurality of second probability values and a plurality of second standard deviations corresponding to the plurality of second grouping ranges at the each sampling time according to the sample space; and
generating a plurality of statistical indicators corresponding to the first grouping set and the second grouping set and outputting a statistical performance ranking result of the first grouping set and the second grouping set accordingly;
wherein the sample space is a time-varying random process-based sample space, the plurality of statistical indicators are generated according to the plurality of first probability values and/or the plurality of first standard deviations corresponding to the plurality of first grouping ranges at each sampling time, and according to the plurality of second probability values and/or the plurality of second standard deviations corresponding to the plurality of second grouping ranges at the each sampling time.

2. The method of claim 1, further comprising:
generating a plurality of first probability differences of a plurality of pair-wised first grouping ranges at the each sampling time according to the plurality of first probability values of the plurality of first grouping ranges at the each sampling time;
generating an average value and a standard deviation of the plurality of first probability differences at the each sampling time;
generating a first distinguishing indicator at the each sampling time according to the average value and the standard deviation of the plurality of first probability differences; and
acquiring a minimal first distinguishing indicator of the first grouping set for all sampling times;
wherein the first distinguishing indicator is a ratio of the average value of the first probability differences to the standard deviation of the first probability differences.

3. The method of claim 2, further comprising:
generating a plurality of second probability differences of a plurality of pair-wised second grouping ranges at the each sampling time according to the plurality of second probability values of the plurality of second grouping ranges at the each sampling time;
generating an average value and a standard deviation of the plurality of second probability differences at the each sampling time;
generating a second distinguishing indicator at the each sampling time according to the average value and the standard deviation of the plurality of second probability differences; and
acquiring a minimal second distinguishing indicator of the second grouping set for all sampling times;
wherein the second distinguishing indicator is a ratio of the average value of the second probability differences to the standard deviation of the second probability differences.

4. The method of claim 3, wherein the plurality of statistical indicators comprise the minimal first distinguishing indicator and the minimal second distinguishing indicator, and a statistical performance of the first grouping set is greater than a statistical performance of the second grouping set when the minimal first distinguishing indicator is greater than the minimal second distinguishing indicator.

5. The method of claim 1, further comprising:
generating a first standard deviation coverage value at the each sampling time by using a linear combination function according to the plurality of first standard deviations corresponding to the plurality of first grouping ranges at the each sampling time;
generating a maximum first probability difference of the plurality of first probability values at the each sampling time according to the plurality of first probability values corresponding to the plurality of first grouping ranges at the each sampling time;
generating a first error degree at the each sampling time according to the first standard deviation coverage value and the maximum first probability difference; and
acquiring a maximum first error degree of the first grouping set for all sampling times;
wherein the first error degree is a ratio of the first standard deviation coverage value to the maximum first probability difference.

6. The method of claim 5, further comprising:
generating a second standard deviation coverage value at the each sampling time by using the linear combination function according to the plurality of second standard deviations corresponding to the plurality of second grouping ranges at the each sampling time;
generating a maximum second probability difference of the plurality of second probability values at the each sampling time according to the plurality of second probability values corresponding to the plurality of second grouping ranges at the each sampling time;
generating a second error degree at the each sampling time according to the second standard deviation coverage value and the maximum second probability difference; and
acquiring a maximum second error degree of the second grouping set for all sampling times;
wherein the second error degree is a ratio of the second standard deviation coverage value to the maximum second probability difference.

7. The method of claim 6, wherein the plurality of statistical indicators comprise the maximum first error degree and the maximum second error degree, and a statistical performance of the first grouping set is greater than a statistical performance of the second grouping set when the maximum first error degree is smaller than the maximum second error degree.

8. The method of claim 1, further comprising:
setting a plurality of weighting values corresponding to the plurality of statistical indicators;
generating a first comprehensive indicator of the first grouping set according to the plurality of weighting values; and
generating a second comprehensive indicator of the second grouping set according to the plurality of weighting values;
wherein the plurality of weighting values are integers or floating point numbers, and the first comprehensive indicator and the second comprehensive indicator are integers or floating point numbers.

9. The method of claim 1, further comprising:
acquiring a first ranking sum of the first grouping set according to the plurality of statistical indicators; and
acquiring a second ranking sum of the second grouping set according to the plurality of statistical indicators;
wherein the first ranking sum and the second ranking sum are two integers greater than two.

10. The method of claim 9, wherein a statistical performance of the first grouping set is greater than a statistical performance of the second grouping set when the first ranking sum is smaller than the second ranking sum.
